(19) United States
(12) Patent Application Publication
(10) Pub. No.: US 2011/0162054 A1
(43) Pub. Date: Jun. 30, 2011

(54) FIRMWARE AND METHOD FOR GENERATING ONE TIME PASSWORDS (OTPs) FOR APPLICATIONS

(75) Inventors: Ashutosh Saxena, Ahmedabad (IN); Tiruvengalam Kanduri, Hyderabad (IN)

(73) Assignee: INFOSYS TECHNOLOGIES LIMITED, Bangalore (IN)

(21) Appl. No.: 12/813,777

(22) Filed: Jun. 11, 2010

(30) Foreign Application Priority Data
Dec. 30, 2009 (IN) 3239/CHE/2009

(51) Int. Cl. H04L 29/06

(52) U.S. Cl. 726/6

(57) ABSTRACT

The invention describes a method, firmware, and computer program product for generating one or more One Time Passwords (OTPs) for one or more applications. The firmware embedded in a computational device receives one or more registration details corresponding to an application from a user. Thereafter, the firmware generates a Dynamic Information Number (DIN) based on at least one of the registration details and an application identifier (SIID). The user registers with the application with the DIN and at least one of the registration details. Further, the user may access the application using an OTP generated by the firmware based on the DIN and the application identifier.

### BACKGROUND

The present invention relates to generating One Time Passwords (OTPs) for one or more applications. More specifically, the present invention relates to a firmware for generating OTPs for one or more applications such as web-based applications.

Data security is one of the most important factors that all organizations and users demand while performing online transactions. For example, customers would like their banks to provide secure online money transfer. Similarly, organizations would like to provide secure online access of data over network to its employees.

To enable secure online transaction, various methodologies and solutions have been proposed in the past for safeguarding data and simultaneously providing secure authentication over the network. These solutions include encrypted user IDs and passwords and public- and private keys-based encryption for accessing the data. However, these methods do not provide a robust mechanism to prevent replay attacks, and hence, fail to provide efficient authentication solutions.

Several organizations have recently started providing token device-based solutions. These organizations provide token devices, such as an RSA token, corresponding to an application, such as net banking or remote website login, to provide secure online transactions to the users. The token generates a key in a predefined format for the purpose of online authentication every time a user wishes to access an application. Post-authentication, the key is discarded and a new key is generated for the next/subsequent access. It is well known in the art that such a key is also called as One Time Password (OTP). Various examples of the predefined format in which OTPs may be generated include a string of characters, an array of numerals, and a string of alphanumeric characters. Such token-based solutions provide data security, but create inconvenience for the users as they have to carry multiple tokens, each corresponding to their respective applications.

In light of the discussion above, there is a need for a method that enables generation of OTPs for multiple applications.

### SUMMARY

The invention provides a firmware, method, and computer program product for generating one or more One Time Passwords (OTPs) for one or more applications.

The firmware, embedded in a computational device, includes a user interface, a DIN (Dynamic Information Number) generation module, a registration module, an OTP generation module and a memory. Prior to generating an OTP for an application, a user receives a Scratch Card (S-card) corresponding to the application from the respective organization. The S-card includes ‘Open information’ and ‘Secret information’. The user enters the open and secret information into the firmware through the user interface. Thereafter, the DIN generation module generates a DIN based on the open and secret information. Subsequently, the registration module registers the user with the application based on the generated DIN and the open information. Post-registration, the user may access the application by providing the OTP generated by the OTP generation module.

The firmware and method discussed above have numerous advantages. The firmware enables the user to generate OTPs for a plurality of applications, thereby avoiding the need for carrying multiple token devices. Further, in the preferred embodiment of the invention, the firmware is embedded in a mobile phone or any gadget, which has memory and computational capabilities, that is typically always carried by the user, and thereby, eliminates the need for carrying additional hardware for generating OTPs.

### BRIEF DESCRIPTION OF THE DRAWINGS

The various embodiments of the invention will hereinafter be described in conjunction with the appended drawings, provided to illustrate and not to limit the invention, wherein like designations denote like elements, and in which:

FIG. 1 illustrates an environment in which various embodiments of the invention may be practiced;

FIG. 2 is a block diagram of a firmware for generating One Time Passwords (OTPs) for one or more applications, in accordance with an embodiment of the invention;

FIG. 3 depicts an exemplary memory structure of the firmware, in accordance with an embodiment of the invention;

FIG. 4 is a flowchart of a method for registering a user with an application, in accordance with an embodiment of the invention; and

FIG. 5 is a flowchart for a method for generating OTPs for the application, in accordance with an embodiment of the invention.

### DETAILED DESCRIPTION

The invention describes a method, firmware, and computer program product for generating one or more One Time Passwords (OTPs) for one or more applications. The firmware embedded in a computational device receives one or more registration details corresponding to the application from a user. Subsequently, the firmware generates a Dynamic Information Number (DIN) based on at least one of the registration details and an application identifier (known as Static Information ID (SIID)). The user registers with the application with the DIN and at least one of the registration details. Post-registration, the user may access the application using an OTP generated by the firmware based on the DIN and the application identifier.

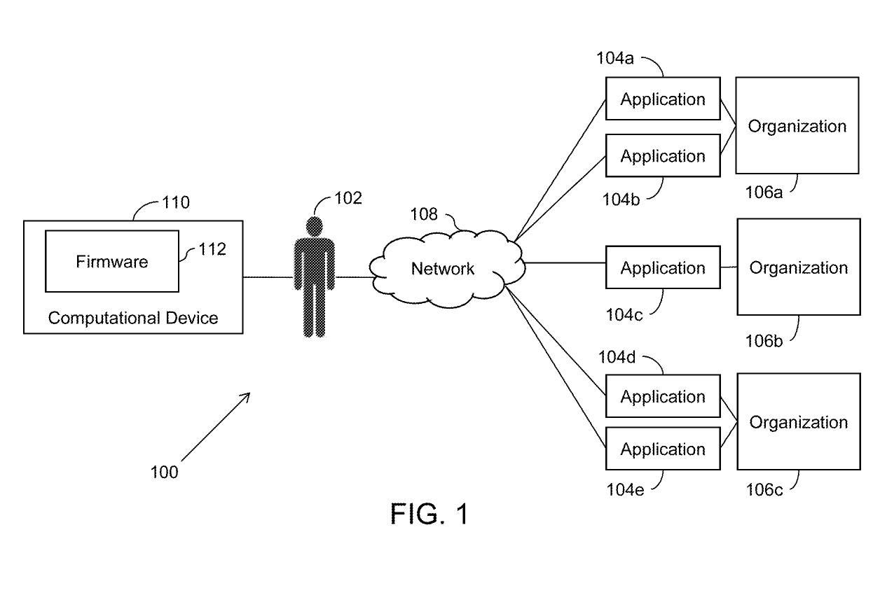

FIG. 1 illustrates an environment 100 in which various embodiments of the invention may be practiced. Environment 100 includes a user 102; one or more applications 104 such as an application 104a, 104b, 104c, 104d, and 104e provided by corresponding one or more organizations 106 such as an organization 106a, 106b, and 106c; a network 108; and a computational device 110 with an embedded firmware 112.

User 102 accesses one or more applications 104 over network 108. Each of applications 104, such as application 104a, is accessed by user 102 upon authentication with respective organizations 106. In various embodiments of the invention, application 104a authenticates user 102 based on one or more authentication details, such as One Time Passwords (OTPs). Furthermore, the OTP for application 104a is generated by firmware 112 embedded in computational device 110.

Various examples of applications 104 may be online banking websites, music download websites, and corporate login websites. Further, it may be apparent to a person skilled in the art that each of applications 104 may be hosted by corresponding organizations at respective servers. Various examples of computational device 110 may be a mobile phone, a personal computer, a laptop, and a palmtop. In various embodiments of the invention, network 108 may be a wired or a wireless network. Various examples of network 108 may include but are not limited to a Local Area network (LAN), Wide Area Network (WAN), Internet, and Wireless LAN.

In various embodiments of the invention, organization 106a may also be referred to as an entity, such as a single person, and thus, organization 106a and the entity may be used interchangeably. Furthermore, applications 104 may be referred to as services offered by products of Software as a Service (SAAS). Therefore, applications 104 and the services may be used interchangeably.

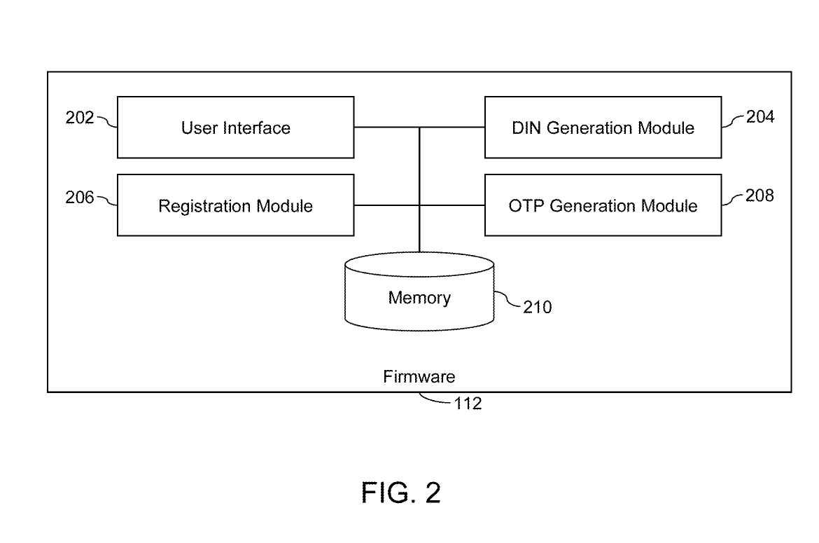

FIG. 2 is a block diagram of firmware 112 for generating One Time Passwords (OTPs) for one or more applications, in accordance with an embodiment of the invention. Firmware 112 includes a user interface 202, a DIN (Dynamic Information Number) generation module 204, a registration module 206, an OTP generation module 208, and a memory 210.

User interface 202 receives one or more registration details from user 102. Thereafter, DIN generation module 204 generates a DIN based on at least one of the one or more registration details and an application identifier. Subsequently, registration module 206 registers user 102 with application 104a based on the DIN and at least one of the registration details. After registration, application 104a authenticates user 102 based on an OTP generated by OTP generation module 208. Further, the DIN, the registration details, and the application identifier are stored in memory 210.

In an embodiment of the invention, user 102 receives a typical scratch card (S-card) corresponding to each of applications 104, such as application 104a, to register with any of organizations 106 such as organization 106a. The S-card is provided by the corresponding organization 106a and includes one or more registration details. In an embodiment of the invention, the registration details may be broadly classified into ‘Open Information’ and ‘Closed/Secret Information’. The secret information is accessed by scratching the S-card.

Thereafter, user interface 202 receives the registration details, both open and secret information, from user 102. DIN generation module 204 then generates a DIN based on the secret and open information. To further elaborate, in an embodiment of the invention, the DIN is generated based on the secret information and Static Information ID (SIID). The SIID, also referred to as application identifier, is derived from the open information. In other words, the SIID may be a subset of the open information or may be generated by using mathematical functions on the open information.

In an embodiment of the invention, open information, secret information, and DIN may be a string of characters, an array of numerals, or a string of alphanumeric characters. Further, it may be apparent to any person skilled in the art that DIN generation module 204 may generate the DIN using one or more algorithms/mathematical functions known in the art.

Subsequently, in an embodiment of the invention, registration module 206 may send the DIN and open information to organization 106a, to register user 102 with corresponding application 104a. It may be apparent to a person skilled in the art that since organization 106a supplied the S-card to user 102, therefore when the open information and the DIN is received by organization 106a form user 102, organization 106a decrypts the open information and the DIN, thereby validating the received information and facilitating the registration of user 102. In another embodiment of the invention, user 102 may manually provide the open information and the DIN to application 104a by accessing the corresponding URL address of application 104a over network 108.

Post-registration with application 104a, user 102 may access application 104a over network 108 to use its services. Application 104a authenticates user 102 each time he/she accesses it based on an OTP generated by OTP generation module 208. OTP generation module 208 generates the OTP based on the DIN and the SIID. Further, after the OTP is used to authenticate user 102 with application 104a, the DIN corresponding to the application is automatically updated. Thus, the next OTP generated for application 104a will be based on the updated DIN and the SIID. In another embodiment of the invention, the DIN may be automatically updated after a predefined time interval. In yet another embodiment of the invention, the DIN may be updated after DIN generation module 204 receives an acknowledgement of usage of the current OTP from organization 106a. The updated DIN is generated based on the SIID and the secret information.

It may be apparent to any person skilled in the art that OTP generation module 208 may generate the OTP by using one or more algorithms/mathematical functions known in the art.

In various embodiments of the invention, for the ease and comfort of user 102, user interface 202 enables the user to provide/assign/define an application differentiator corresponding to each of applications 104. Thus, user 102 may select an application differentiator “2” (depicted in table 1) and generate an OTP corresponding to XYZ net banking website (an exemplary application name). It may be apparent to any person skilled in the art that the application differentiator corresponding to application 104a may be predefined by organization 106a.

In another embodiment of the invention, user interface 202 also enables user 102 to store a Personal Identification Number (PIN) corresponding to each of applications 104. It may be apparent to any person skilled in the art that the PIN facilitates additional security and prevents anyone other than user 102 to generate an OTP for application 104a. In yet another embodiment of the invention, the OTP may also be generated based on the DIN, the SIID, and the PIN corresponding to application 104a. It is well known in the art that the PIN may be a string of characters, an array of numerals, or a string of alphanumeric characters. In various embodiments of the invention, the PIN corresponding to application 104a may be changed by user 102.

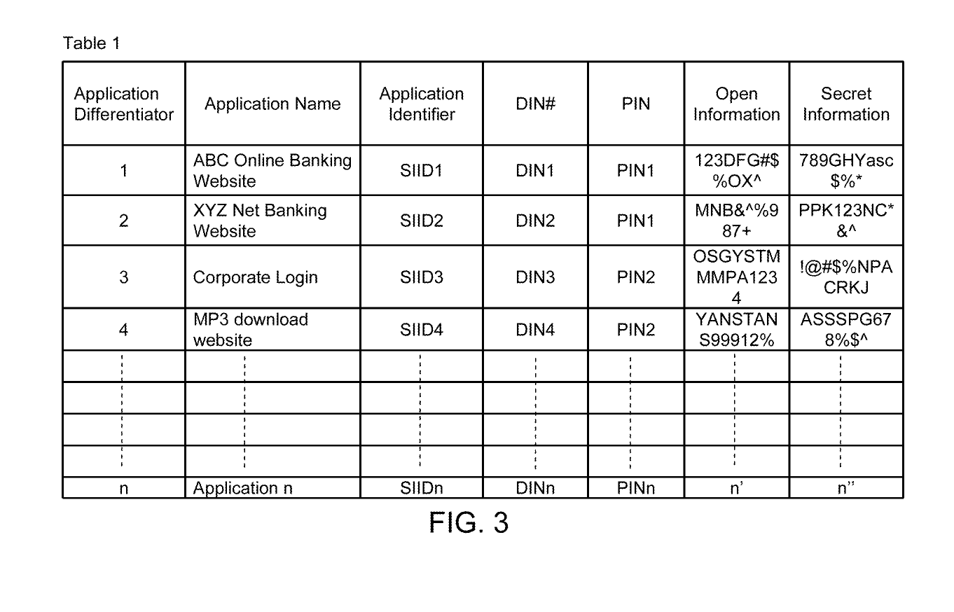

The application differentiator, the application name, the DIN, the SIID, the PIN, and the open and secret information corresponding to each of applications 104 are stored in memory 210. An exemplary table 1 storing the DIN, the SIID, the PIN, the application differentiator, the application name, etc., is depicted in FIG. 3. It may be apparent that the storage depicted in the table is for exemplary purposes only and any other suitable data structures may be used to store details corresponding to each of applications 104 in memory 210.

In various embodiments of the invention, firmware 112 utilizes the computational capabilities of a microprocessor of computational device 110. In addition to the processing capabilities, the display functionalities of computational device 110 are also utilized by firmware 112. In other words, user interface 202 interacts with the display functionalities of computational device 110 to display the OTP, the DIN, the PIN, the application differentiator, etc., to user 102. In an alternate embodiment of the invention, user interface 202 may be exterior to firmware 112 and the display functionalities of computational device 110 may directly be used by firmware 112 to display the OTP, the DIN, the PIN, the application differentiator, etc., to user 102.

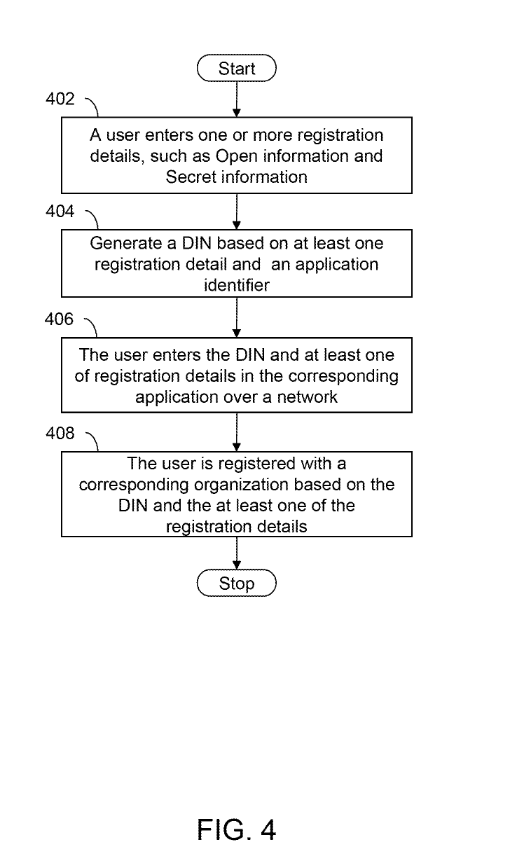

FIG. 4 is a flowchart of a method for registering a user, such as user 102, with an application, such as application 104a, in accordance with an embodiment of the invention.

In various embodiments of the invention, to register with the application, the user receives a Scratch Card (S-Card) from the corresponding organization, such as organization 106a. The S-card includes one or more registration details, i.e. ‘Open Information’ and ‘Closed Information’. The S-card and its corresponding details have been explained in detail in conjunction with FIG. 2. It may be apparent to any person skilled in the art that the organization may also appropriately maintain the registration details disclosed in the S-card. For example, the organizations may maintain the registration details at respective servers, data centers, databases, etc.

Once the user obtains the open and secret information, the user may, at 402, enter the open information and secret information into a firmware, such as firmware 112, embedded in a computational device such as computational device 110. In an embodiment of the invention, the computational device is a mobile phone. Thereafter, at 404, a Dynamic Information Number (DIN) is generated based on the secret and open information. The generation of the DIN has been explained in detail in conjunction with FIG. 2. At 406, the user may enter the generated DIN and the open information into the application of the corresponding organization over a network such as network 108. For example, the user may access the website/web-application and may enter the DIN and open information accordingly. In an alternate embodiment of the invention, the firmware may directly send/transmit the DIN and the open information to the application over the network.

Subsequently, at 408, the application may then register the user based on the received DIN and the open information. It may be apparent to any person skilled the art that the organization registers the user for the corresponding application by comparing the pre-stored details corresponding to the S-card and the received open information and the DIN. To further elaborate, since the DIN is generated by encrypting the secret information and a SIID (derived from the open information), the organization accordingly decrypts the received details based on the pre-stored open and secret information.

After registration, the user may access the application to use the service. The user thereon always provides a One Time Password (OTP) to access services of the applications.

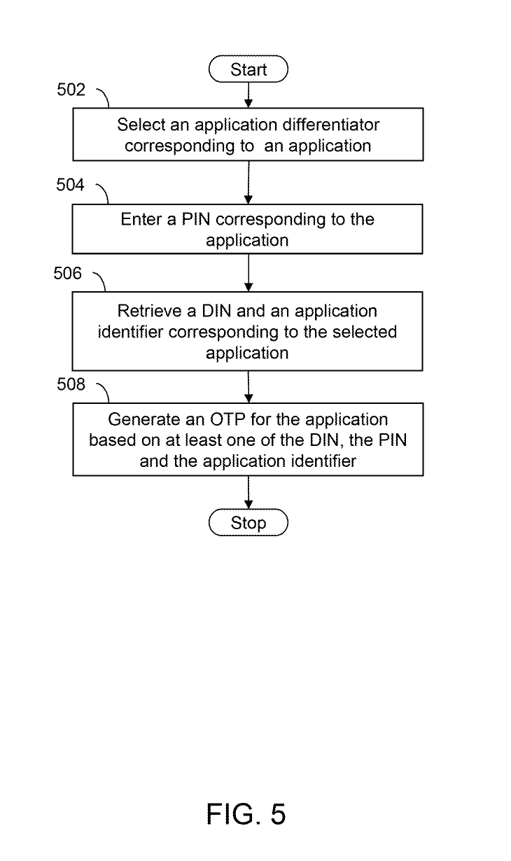

FIG. 5 is a flowchart for a method for generating OTPs for the application, in accordance with an embodiment of the invention.

In various embodiments of the invention, the firmware embedded in the computational device enables the user to generate an OTP for the application. The user may store a list of the registered applications in the memory. It may be apparent to any person skilled in the art that these are the applications for which the user may like to generate the OTP at any point in time. Further, each of the registered applications may be assigned an application differentiator.

To initiate the process for generating the OTP for the application, the user may first select the application differentiator, at 502, corresponding to the application that he/she wishes to access. Thereafter, at 504, the user enters a Personal Identification Number (PIN) corresponding to the application. Subsequently, at 506, based on the validity of the entered PIN, a DIN and an application identifier (SIID) corresponding to the application is retrieved from the memory of the firmware and the OTP is generated based on at least one of the PIN, the SIID and the DIN at 508.

As explained earlier, the firmware maintains the SIID and DIN corresponding to each application. Thus, whenever the user selects the application differentiator from the list, the firmware retrieves the corresponding DIN from the memory. Further, the DIN is updated after the OTP generated by the DIN is used to authenticate the user with the application. Thus, the OTP generated for the subsequent authentication is generated based on the updated/new DIN. Similarly, the firmware may generate OTPs for various applications. Further, the DIN/OTP is generated by using various mathematical functions and algorithms known in the art. In various embodiments of the invention, the DIN, the PIN, and the SIID may be a string of characters, an array of numerals, or a string of alphanumeric characters.

It may be appreciated by any person skilled in the art that the method steps mentioned in FIGS. 4 and 5 may be embodied as software programs in the firmware.

The firmware and method as disclosed have numerous advantages. The firmware enables the user to generate OTPs for a plurality of applications, thereby eliminating the need for carrying multiple tokens. Further, in the preferred embodiment of the invention, the firmware is embedded in a mobile phone or any gadget, which has memory and computational capabilities, that is typically always carried by the user, and thereby, eliminates the need for carrying additional hardware to generate OTPs.

The firmware for generating one or more OTPs for one or more applications, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, etc. The storage device can also be other similar means for loading computer programs or other instructions into the computer system. The computer system also includes a communication unit, which enables the computer to connect to other databases and the Internet through an Input/Output (I/O) interface. The communication unit also enables the transfer as well as reception of data from other databases. The communication unit may include a modem, an Ethernet card, or any similar device which enable the computer system to connect to databases and networks such as Local Area Network (LAN), Metropolitan Area Network (MAN), Wide Area Network (WAN) and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for generating one or more OTPs for one or more applications. The computer program product includes a computer usable medium having a set program instructions comprising a program code for generating one or more OTPs for one or more applications. The set of instructions may include various commands that instruct the processing machine to perform specific tasks such as the steps that constitute the method of the present invention. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

What is claimed is:

1. A firmware for generating One Time Passwords (OTPs) for one or more applications, the firmware being embedded in a computational device of a user, the firmware comprising:
a. a registration module configured for registering the user for each of the one or more applications, wherein a Dynamic Information Number (DIN) corresponding to each application is received by the registration module at the time of the registration of each application;
b. a memory configured for storing the DIN corresponding to each application, an application identifier corresponding to each application and a Personal Identification Number (PIN) of the user;
c. a user interface configured for receiving the PIN and an application differentiator corresponding to an application of the one or more applications, the PIN and the application differentiator being entered by the user; and
d. an OTP generation module configured for generating an OTP for the application corresponding to the entered application differentiator, the OTP being generated based on the validity of the entered PIN, the application identifier and the DIN corresponding to the application.

2. The firmware according to claim 1, wherein the OTP generation module is further configured for generating the OTP based on at least one of the PIN, the application identifier and the corresponding DIN.

3. The firmware according to claim 1, wherein the application differentiator corresponding to each application is defined by the user or by corresponding organization.

4. The firmware according to claim 1, wherein the application identifier corresponding to each application is derived from at least one registration detail provided by a corresponding organization.

5. The firmware according to claim 4, wherein each application is provided by the corresponding organization.

6. The firmware according to claim 1 further comprising a DIN generation module configured for generating the DIN corresponding to each of the one or more applications, wherein the DIN is generated based on at least one of one or more registration details and the application identifier, the one or more registration details being provided by a corresponding organization.

7. The firmware according to claim 6, wherein the DIN generation module is further configured for updating the corresponding DIN, the DIN being updated after the OTP generation module generates the OTP for the application.

8. The firmware according to claim 7, wherein the OTP generation module is further configured for generating another OTP for the application based on the corresponding updated DIN.

9. The firmware according to claim 6, wherein the DIN generation module is further configured for updating the corresponding DIN after receiving an acknowledgement from the corresponding organization.

10. The firmware according to claim 1, wherein the user interface is further configured for displaying at least one of the application differentiator, the PIN, the DIN and the OTP on the computational device.

11. The firmware according to claim 1, wherein the user interface is further configured for facilitating the user to change the PIN corresponding to the application.

12. A method for generating One Time Passwords (OTPs) for one or more applications, the OTPs being generated by a firmware embedded in a computational device of a user, the method comprising:
a. receiving a Personal Identification Number (PIN) corresponding to the user and an application differentiator corresponding to an application of the one or more applications, the PIN and the application differentiator being entered by the user; and
b. generating an OTP for the application corresponding to the entered application differentiator, the OTP being generated based on a Dynamic Information Number (DIN) corresponding to the application, an application identifier and the validity of the entered PIN, wherein the DIN is received by the user at the time of registration of the application.

13. The method according to claim 12 further comprising generating the OTP based on at least one of the PIN, the application identifier and the corresponding DIN.

14. The method according to claim 12 further comprising defining the application differentiator corresponding to each application, the application differentiator being defined by the user or by corresponding organization.

15. The method according to claim 12, wherein the application identifier corresponding to each application is derived from at least one registration detail provided by a corresponding organization.

16. The method according to claim 15, wherein each application is provided by the corresponding organization.

17. The method according to claim 12 further comprising generating the DIN corresponding to each of the one or more applications, wherein the DIN is generated based on at least one of one or more registration details and the application identifier, the one or more registration details being provided by a corresponding organization.

18. The method according to claim 12 further comprising displaying at least one of the application differentiator, the PIN, the DIN and the OTP on the computational device.

19. The method according to claim 12 further comprising updating the corresponding DIN after generating the OTP for the application.

20. The method according to claim 19 further comprising generating another OTP for the application based on the corresponding updated DIN.

21. The method according to claim 19, wherein the corresponding DIN is updated after receiving an acknowledgement from a corresponding organization.

22. The method according to claim 12 further comprising facilitating the user to change the PIN corresponding to the application.

23. A computer program product being embedded in a computational device, the computer program product comprising a computer usable medium having a computer readable program code embodied therein for generating One Time Passwords (OTPs) for one or more applications, the computer readable program code performing:
a. receiving a Personal Identification Number (PIN) corresponding to a user and an application differentiator corresponding to an application of the one or more applications, the PIN and the application differentiator being entered by the user; and
b. generating an OTP for the application corresponding to the entered application differentiator, the OTP being generated based on a Dynamic Information Number (DIN) corresponding to the application, an application identifier and the validity of the entered PIN, wherein the DIN is received by the user at the time of registration of the application.

24. The computer program product according to claim 23, wherein the computer readable program code further performs generating the OTP based on at least one of the PIN, the application identifier and the corresponding DIN.

25. The computer program product according to claim 23, wherein the computer readable program code further performs generating the DIN corresponding to each of the one or more applications, wherein the DIN is generated based on at least one of one or more registration details and the application identifier, the one or more registration details being provided by a corresponding organization.

26. The computer program product according to claim 23, wherein the computer readable program code further performs displaying at least one of the application differentiator, the PIN, the DIN and the OTP on the computational device.

27. The computer program product according to 23, wherein the computer readable program code further performs updating the corresponding DIN after generating the OTP for the application.

28. The computer program product according to claim 27, wherein the computer readable program code further performs generating another OTP for the application based on the corresponding updated DIN.

29. The computer program product according to claim 27, wherein the corresponding DIN is updated after receiving an acknowledgement from a corresponding organization.

30. The computer program product according to claim 23 further performing facilitating the user to change the PIN corresponding to the application.
